(19) United States
(12) Patent Application Publication
(10) Pub. No.: US 2017/0074457 A1
(43) Pub. Date: Mar. 16, 2017

(54) Hydrogen Produced On Site

(71) Applicant: Roger E Billings, Independence, MO (US)

(72) Inventor: Roger E Billings, Independence, MO (US)

(21) Appl. No.: 14/852,554

(22) Filed: Sep. 12, 2015

(51) Int. Cl. F17C 5/06; H01M 16/00; C01B 3/38

(52) U.S. Cl. CPC F17C 5/06; C01B 3/38; H01M 16/003; F17C 2221/012; F17C 2265/065; F17C 2270/0184; C01B 2203/0233; C01B 2203/1241; C01B 2203/1223; C01B 2203/84; H01M 2250/20

(57) ABSTRACT

The idea of operating vehicles on hydrogen has potential of reducing vehicle emissions, improving vehicle operational efficiency, and to reducing the dependency on petroleum. Although hydrogen can be commercially produced from various hydrocarbon feedstocks, the remaining limitation to wide-scale deployment is the lack of a hydrogen fuel distribution infrastructure to replace petroleum. By producing hydrogen on the site of the vehicle refueling station, the need for a new distribution infra structure is eliminated.

### BACKGROUND OF THE INVENTION

The demand for nonpolluting sources of electricity is expanding. In addition to problems associated with nitric oxide, sulfur oxide, carbon monoxide and particulates; recent concerns about global climate change are driving the demand for pollution free power generation systems that substantially reduce carbon dioxide, a major component of greenhouse gas.

Hydrogen energy has been demonstrated as a clean alternative to hydrocarbon fuels. The byproduct of hydrogen/oxygen combustion is pure water vapor. Hydrogen can be produced from water utilizing almost any source of energy. While many renewable energy sources are nonpolluting, they are often considerably more expensive than hydrocarbon fuels. When hydrocarbons are used to generate hydrogen, carbon dioxide is produced as a byproduct in roughly the same proportions that would result from the direct combustion of the hydrocarbon fuel. If hydrogen could be utilized more efficiently to power vehicles, the effective cost of hydrogen produced from renewable sources would be decreased thereby becoming more competitive with other fuel sources. Furthermore, a more efficient method of utilizing hydrogen to power vehicles could be provided, even hydrogen produced from hydrocarbons would result in an overall reduction of carbon dioxide emissions, since a smaller amount of hydrocarbon would be required to produce an equivalent amount of driving.

Hydrogen-powered vehicles have long been pitched as a greener alternative to gasoline-powered vehicles. Hydrogen Energy Corporation founder, Dr. Roger E. Billings, built the first working hydrogen car in 1966¹. The Model-A prototype was an important proof of concept, but the converted internal combustion engine cost more to operate on hydrogen than gasoline.

In 1991, Billings demonstrated the first hydrogen fuel cell car². A fuel cell is a membrane device with no moving parts that turns hydrogen into electricity which is able to power a car three times more efficiently than an internal combustion engine. With the high efficiency fuel cell, the cost of operating the car on hydrogen is less than on gasoline.

The remaining problem holding back the commercialization of hydrogen fueled cars is the lack of a hydrogen fuel distribution system. In spite of the fact that auto makers have put hydrogen fuel cell cars on the road, the cars are limited to operating inside a small area on either coast where research refueling stations have been set up. Without a full scale hydrogen distribution system, the idea of a hydrogen energy economy is not likely to get off the ground.

It has been estimated that the cost to build a hydrogen infrastructure to replace petroleum would be $200 trillion³. In the absence of an existing large scale hydrogen fleet, such a costly investment is unlikely. On the other hand, without the hydrogen infrastructure, the deployment of significant numbers of hydrogen-fueled vehicles is not feasible. Like a “catch 22”, the incredibly beneficial hydrogen economy is on hold.

Some researchers have suggested the idea that hydrocarbon fuels could be reformed on board a vehicle to produce hydrogen which could then be used to power the vehicle. Attempts to produce an on board hydrocarbon fuel reformer have so far been unsuccessful due to problems with complexity of systems, resulting gas purity, and maintenance. For example, the compound Sulphur found in many hydrocarbon fuels has the effect of poisoning fuel cell catalyst and membrane materials thereby shortening the useful life span of the equipment and making this option unfeasible.

### SUMMARY OF THE INVENTION

The present invention is directed towards a solution that would jump-start hydrogen energy systems by making is possible to utilize the existing hydrocarbon distribution infrastructure as an interim solution to the hydrogen production and distribution problem. Instead of trying to reform fuel on board the vehicle, a hydrogenator is installed at the point of use, or in this case, at the commercial refueling station.

In a preferred embodiment of the invention, gasoline is utilized to produce hydrogen to refuel vehicles right at the refueling station. The hydrogen “produced on site” process utilizes gasoline from the existing underground tanks as the feed stock for the hydrogen production which takes place upon demand for refueling hydrogen vehicles without the need for large storage facilities. In the process, steam is reacted with the gasoline on the surface of a novel catalyst eventually resulting in the hydrogen to refuel the vehicles and an amount of CO₂ that is vented into the environment. If the hydrogen fuel cell is operated a low current density to achieve high efficiency, only 35% as much CO₂ is unloaded on the atmosphere as would be the case if the same vehicle were to burn gasoline. By this process, the impact of greenhouse gases resulting from automobiles and other vehicles is brought under control and the total amount of gasoline consumption is reduced by about 50%. “It is really a breakthrough”.

The hydrogen produced on site process will allow for rapid commercialization of hydrogen energy systems since the total production, refinement, and distribution of oil is well establish as in place. The process will extend the utilization of existing production and refinement investments since the total amount of oil required will be reduced drastically. Even more important in the long term, is the fact that this deployment of commercial scale hydrogen vehicles opens the door for the utilization of hydrogen produced entirely from renewable resources including solar, wind, and geothermal, in which case there is no CO₂ burden to the atmosphere. The system is also perfectly compatible with power produced by nuclear fusion and other clean energy sources of the future.

### BRIEF DESCRIPTION OF THE DRAWING

In order to better appreciate how the above recited and other advantages and objects of the invention are obtained; a more particular description of the invention briefly described above will be rendered by reference to specific embodiments thereof which are illustrated in the appended drawing. Understanding that this drawing depicts only typical embodiments of the invention and are not therefore to be considered limiting of its scope, the invention will be described and explained with additional specificity and detail through the use of the accompanying drawing in which:

FIG. 1 is a block diagram showing the relationship of the gasoline storage, the hydrogenator, the hydrogen refueling station and the hydrogen vehicle.

### DETAILED DESCRIPTION OF THE INVENTION

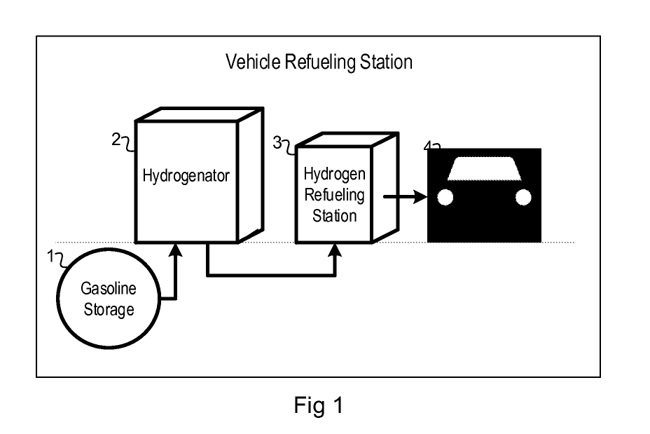

Referring to FIG. 1, an apparatus of the present invention preferably consists of a source of fuel or in this case, gasoline 1, which is already stored usually below ground in tanks from which it is pumped to refuel vehicles. The gasoline is pumped into a hydrogenator 2 which is a device that produces hydrogen using the gasoline fuel as a feed stock.

The resulting hydrogen gas is then transferred to the Hydrogen Refueling Station 3 from which appliance it is transferred to the vehicle 4.

The hydrogen can be produced by any method or combination of methods including water electrolysis utilizing power from solar, wind, hydroelectric, or nuclear power, methane reformation, hydrocarbon gasification, or any other source. In the case of the preferred embodiment, the hydrogen is produced from gasoline in a steam reformation process on the surface of a novel catalyst.

The reformer is a simple reaction device such as has been described in the literature. Since the reformer is stationary, and is intended to provide hydrogen for multiple vehicles, it is not plagued by the same problems associated with on board reformers.

The resulting hydrogen gas stream would then likely be passed through a refrigeration drying system and further processed to remove impurities perhaps by a process such as a molecular sieve.

What is claimed is:

1. A system for distributing hydrogen fuel to vehicles comprising:
a distributable source of hydrocarbon fuel;
a hydrogenator which is capable of producing hydrogen from the hydrocarbon fuel at or near the point of vehicle refueling;
a hydrogen refueling station that is capable of safely refueling hydrogen vehicles; and
at least one or more hydrogen powered vehicles that are capable of using the hydrogen fuel to propel the vehicle.

2. The system of claim 1, wherein the source of hydrocarbon fuel is gasoline.

3. The system of claim 1, wherein the source of hydrocarbon fuel is methane.

4. The system of claim 1, wherein the source of hydrocarbon fuel is methanol.

5. The system of claim 1, wherein the hydrogen production process of the hydrogenator is steam reformation on the surface of a novel catalyst.

6. A method of distributing hydrogen fuel to vehicles comprising the steps of:
reforming fuel stored in tanks at refueling stations into hydrogen;
refueling hydrogen vehicles safely with the generated hydrogen;
operating the vehicles powered by hydrogen fuel for some useful purpose.

7. The method of claim 6, wherein the fuel stored in tanks is gasoline.

8. The method of claim 6, wherein the fuel stored in tanks is methanol.

9. The method of claim 6, wherein the fuel stored in tanks is diesel fuel.

10. The method of claim 6, wherein the fuel stored in tanks is natural gas delivered to the station via underground pipeline.
